(19) United States
(12) Patent Application Publication
(10) Pub. No.: US 2010/0000105 A1
(43) Pub. Date: Jan. 7, 2010

(54) Level having a strikable device

(76) Inventors: Yuexiang Zhang, Nanjing (CN); Ming Chen, Nanjing (CN); Jianjun Shuang, Nanjing (CN)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/459,645

(22) Filed: Jul. 6, 2009

(30) Foreign Application Priority Data
Jul. 7, 2008 (CN) 200820040763.9

(51) Int. Cl. G01C 9/02

(52) U.S. Cl. 33/365

(57) ABSTRACT

The present invention provides a level, having a body including a bottom surface for contacting a surface to be measured, at least one level indicating device mounted to the body, and a strikable device is mounted to the level. The strikable device has a top surface which is strikable by a user, and a bottom surface to contact the surface to be measured.

### CROSS-REFERENCE TO RELATED APPLICATIONS

This application claims priority under 35 U.S.C. 119 to CN 200820040763.9 filed Jul. 7, 2008, and is hereby incorporated by reference.

### BACKGROUND OF THE INVENTION

The present invention relates to geometric instruments and, more particularly, to a level, sometimes referred to as a “spirit level” used by carpenters and the like.

A typical level, which is widely used in construction, decorating and the like, measuring and assuring that surfaces are horizontal, generally comprises a main body which is made of stretch bending material and has at least one plane surface and two bubble indicator vials mounted on the main body. The level made of stretch bending material is light weight and can be machined easily. Disadvantages with such levels are that the levels can be easily damaged during use especially during impact operation. For example, the level is typically used to measure whether tiles or floor boards are horizontally laid. The level is placed so that the plane surface of the level contacts the tile or the floor board to be measured. The user reads the bubble indicators on the level and determines whether the tile or the floor board to be measured is horizontal or level. T he tile or floor board may be struck or impacted with a rubber hammer or other like tool, and if the tile or the floor board is not horizontal or level, repeat measuring and impacting operations may be required until the tile or the floor board is substantially horizontal. During the tile or floor board installation process, the impact and measuring steps cannot be carried out simultaneously, which results in low efficiency of the laying work. The present invention overcomes current technical problems and provides an improved level with a simple and compact structure and is convenient to use.

### SUMMARY OF THE INVENTION

The level of the present invention comprises a body having two opposing ends, and a bottom surface for contacting a surface to be measured, at least one level indicating device mounted to the body and an impact receiving or strikable device mounted to the level. The impact receiving or strikable device comprises a top surface which is impacted by a tool, and a bottom surface which is operable to contact the surface to be measured.

By incorporating a strikable device, the level can be directly hit or impacted by a suitable tool wherein the surface to be measured can be indirectly impacted and adjusted to be horizontal or level during the measuring operation. Furthermore, the device is preferably made of material that will absorb the impact and will not damage or distort the level. Therefore, the level can be impacted directly such that the surface of the tile or the floor board can be measured while the surface is adjusted until the level indicates that the surface of the tile or the floor board is horizontal. Thus, the efficiency of the installation of the tile or the floor board is increased.

### BRIEF DESCRIPTION OF THE DRAWINGS

The invention will be described in detail in conjunction with the accompanying drawings, wherein

FIG. 1 is a partial perspective view of a level of a first embodiment according to the present invention.

FIG. 2 is a cutaway view along a longitudinal axis of the level shown in FIG. 1.

FIG. 3 is a perspective view of a strikable device of the level shown in FIG. 1, wherein the strikable device is in a closed state.

FIG. 4 is a perspective view of the strikable device of the level shown in FIG. 1, wherein the strikable device is in an open state.

FIG. 5 is a partial cutaway view along a longitudinal axis of a level of a second embodiment according to the present invention.

FIG. 6 is a partial perspective view of a level of a third embodiment according to the present invention.

FIG. 7 is a partial front view of the level shown in FIG. 6.

FIG. 8 is a cutaway view along line of A-A of the level shown in FIG. 6.

### DETAILED DESCRIPTION OF THE PREFERRED EMBODIMENTS

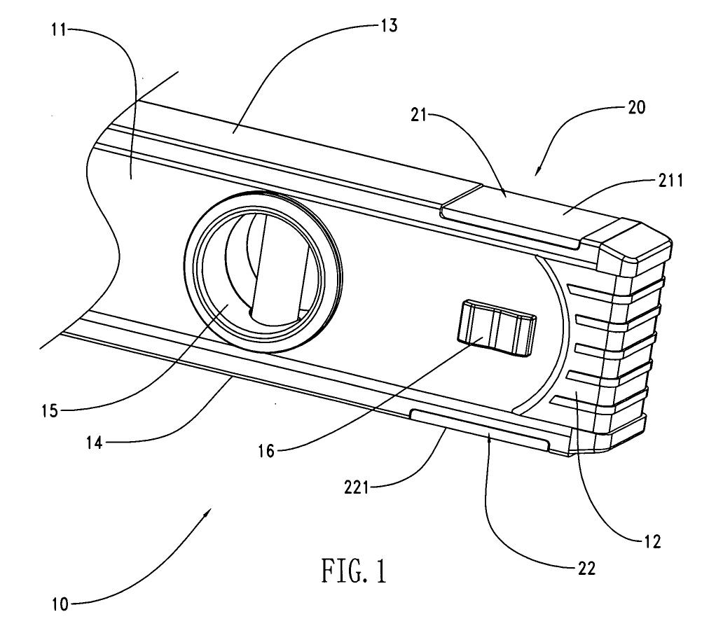

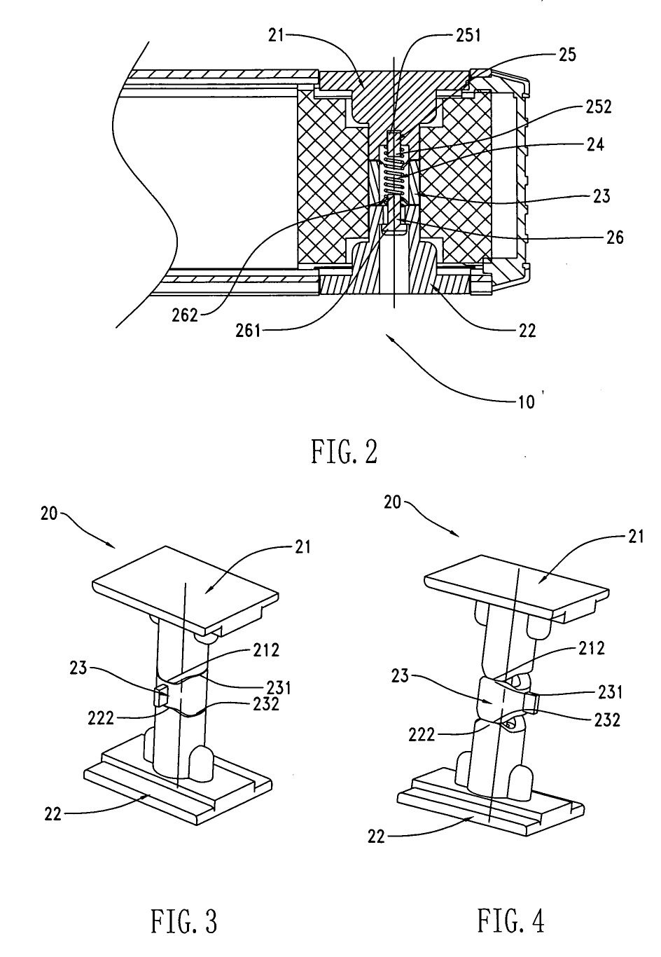

FIG. 1 is a partial perspective view of a level 10 of a first embodiment according to the present invention. The level 10 comprises an elongate body 11 having two opposing ends and two end caps 12 one mounted on each end of the body 11 (only one end cap is shown), respectively. The body 11 is formed having a top surface 13 and a bottom surface 14 which is parallel to the top surface 13. For general measurement, the bottom surface 14 is placed in contact with a surface to be measured. The end caps 12 are made of material which is impact resistant, such as rubber and the like, so that the body 11 of the level 10 can be prevented from being damaged when the level is accidentally dropped. At least one bubble indicator vial 15 is mounted on the body 11 for users to observe whether the surface to be measured is level. Referring to FIGS. 2-4, a strikable device 20 is mounted to the body 11, and comprises a top block 21, a support block 22, a rotatable block 23, and a return spring 24. The top block 21, the support block 22 and the rotating block 23 are assembled to be a strikable device 20 through the spring 24 and bolts 25, 26. A first end 251 of the first bolt 25 is connected to the top block 21, while a second end 252 is connected to the other end of the spring 24. A first end 261 of the second bolt 26 is provided to extend into the support block 22, and a second end 262 of the second bolt 26 is connected to one end of the spring 24. The top block 21, the support block 22 and the rotating block 23 are secured together under a pulling force of the spring 24 so as to be fixed relative to the body 11.

FIG. 1 shows the strikable device 20 in a closed state wherein a strikable surface 211 of the top block 21 is aligned with the top surface 13 of the level and a support surface 221 of the support block 22 is aligned with the bottom surface 14. With the effect of the pulling force of the spring 24, the strikable device 20 is fixed with respect to the body 11, wherein lower portions of the strikable device 20 are located within the body 11 of the level. An operation button 16 is connected to the strikable device 20 and mounted on the body 11 for convenient operation. When the operation button 16 is pushed, the top block 21 and the support block 22 are actuated to move along a direction perpendicular to a longitudinal direction of the body 11, so that the strikable device 20 is freely movable along the direction with respect to the body 11, such that the bottom of the strikable device 20 extends outside the body 11 along with the movement of the strikable device 20. When the strikable surface 211 of the top block 21 is struck or impacted by an appropriate tool, a majority of the force is delivered not to the body 11 of the level 10 but to the surface to be measured so as to avoid damage to the structure of the body or affecting the precision of the level.

FIG. 3 is a perspective view of the strikable device 20 in a closed state of a first position, wherein a cam edge 212 of the top block 21 closely contacts with a first cam edge 231 of the rotating block 23, and a cam edge 222 of the support block 22 closely contacts with a second cam edge 232 of the rotating block 23. Pushing the operation button 16 in a first position actuates the rotating block 23 to rotate to a second position as shown in FIG. 4, thus protruding portions of the first and second cam edges 231, 232 to contact protruding portions of the cam edge 212 of the top block 21 and the cam edge 222 of the support block 22, respectively, with a result that the top block 21 and the support block 22 move outward with respect to the body 11 of the level 10 along the direction which is perpendicular to the longitudinal direction of the body 11. In this manner the strikable device 20 is freely movable with respect to the body 11 such that the strikable surface 211 of the top block 21 can extend outside the top surface 13 of the level for convenient impact by users. When the impacting operations are completed, the operation button 16 can be moved to a second position opposite to the first position thereby actuating the rotating block 23 to a returning position as shown in FIG. 3. T he top block 21 and the support block 22 are actuated toward the rotating block 23 and contact the rotating block 23 through the pulling force of the spring 24.

The top block 21, the support block 22 and the rotating block 23 are preferably made of impact-resistant material, such as metal or high-strength plastic. On the support surface 221 of support block 22 which contacts the surface to be measured, resilient material, such as rubber or the like, can be attached so as to protect the surface to be measured.

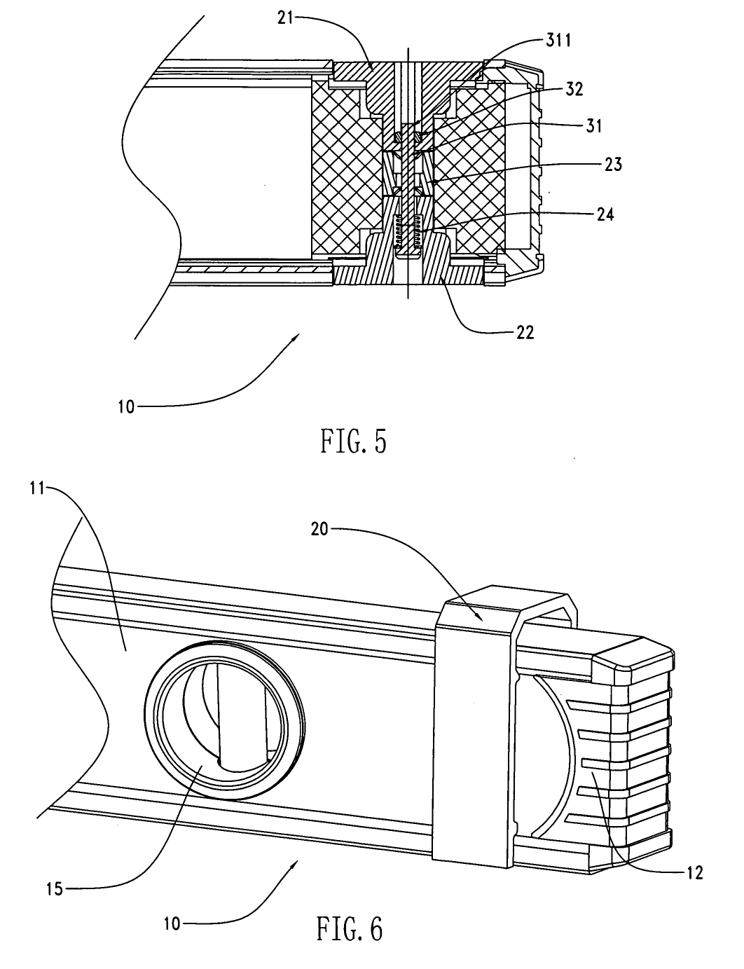

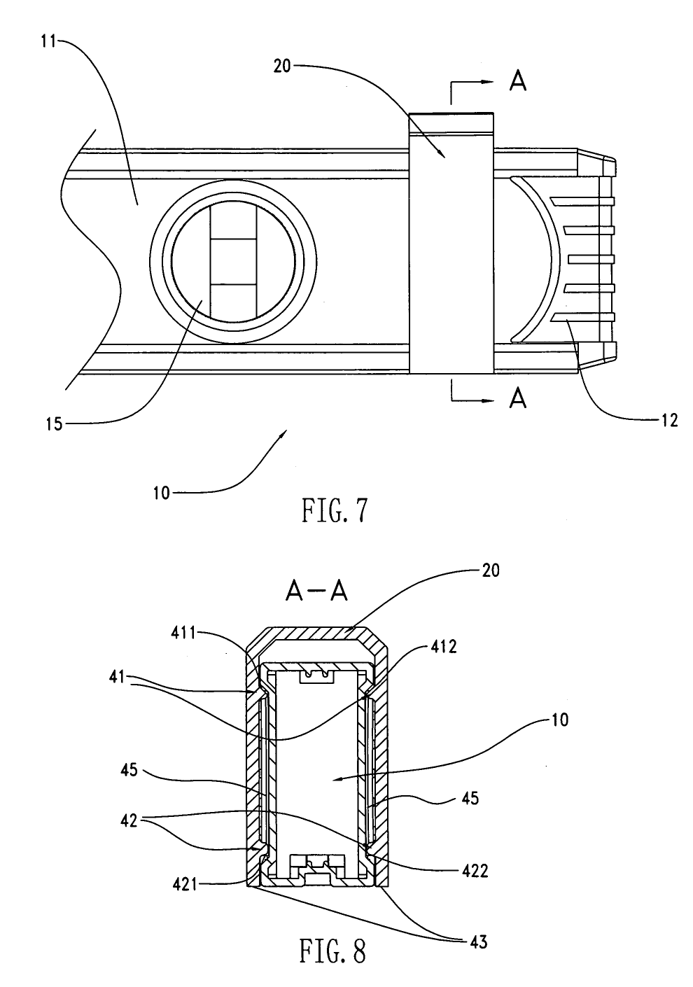

FIG. 5 is a partial cutaway view of a second embodiment according to the present invention and shows a second type of structure of the strikable device 20. In the second embodiment, the strikable device 20 comprises the top block 21, the support block 22 and the rotating block 23, which are connected with each other through arrangement of a bolt 31 and a nut 32. One end 311 of the bolt 31 is fixedly mounted to the top block 21 through the nut 32, while the support block 22 and the rotating block 23 are connected but not fixed to the bolt 31. A spring 24 is mounted between the bolt 31 and the support block 22, and a pushing force of the spring 24 forces the top block 21, the support block 22 and the rotating block 23 to be pressed together.

Pushing the operation button 16 actuates the rotating block 23 to rotate, so that the strikable block 21 and the support block 22 move outward with respect to the body 11 of the level, changing the engagement positions between the cam edges of the top block 21, the support block 22 and the rotating block 23, as shown in FIGS. 3 and 4, thereby causing the strikable surface 211 of the top block 21 to extend outside the top surface 13 of the level for convenient impacting by an appropriate tool.

Those of ordinary skill in the art may easily understand that many other connecting arrangements can be utilized for connecting the top block 21, the support block 22 and the rotating block 23, and further that the rotating block 23 can be formed to be a single member with the top block 21 or the support block 22, which can function the same as described above.

In both the first and second embodiments, the strikable device 20 is mounted to the body 11 of the level. Optionally, the strikable device 20 may be mounted to one of the end caps 12.

FIG. 6 is a partial perspective view of a third embodiment of the present invention. As shown in FIG. 6, the strikable device 20 is mounted on outer surfaces of the body 11 of the level, and is moveable along the longitudinal direction of the body of the level. When the surface to be measured needs to be adjusted, the strikable device 20 is moved to a proper position with respect to the body and struck. As shown in FIG. 8, a first pair of protrusions 41 and a second pair of protrusions 42 are formed on inner surfaces of the strikable device 20. The first pair of protrusions 41 has oblique surfaces 411 and 412, and the second pair of protrusions 42 has oblique surfaces 421 and 422. The strikable device 20 is movably mounted on the body of the level through engagement between the oblique surfaces 411, 412, 421, 422 and sliding recesses 45 formed on the body 11 of the level. In a direction perpendicular to the longitudinal direction of the body 11, an interval between the first pair of protrusions 41 and the second pair of protrusions 42 is narrower than a width of the sliding recesses 45, so that the strikable device 20 is freely movable along the direction perpendicular to the longitudinal direction of the body. With such structure, the striking force will be delivered not to the body 11 of the level, but to the surface to be measured, so as to avoid distortion and damage to the body of the level. Resilient material can be attached to the bottom surfaces 43 of the strikable device for protecting the surface to be measured. In the present embodiment, each of the recesses 45 is formed to receive one of the first pair of protrusions and one of the second pair of protrusions simultaneously. Optionally, the positions of the protrusions and the sliding recesses can be exchanged. Optionally, the strikable device may be mounted to the end cap of the level.

Those of ordinary skill in the art will easily understand the other types of level indicating devices, such as electrical level measuring and displaying unit and the like, are useful in the present invention.

The above described preferred embodiments are intended to illuminate the principle of the present invention, but not to limit its scope. It can be easily understood for those ordinary skilled in the art that many other modifications and variations of these preferred embodiments will be apparent and may be made without departing from the spirit and the scope of the invention as defined in the following claims.

We claim:

1. A level comprising:
a body having two opposing ends and a bottom surface for contacting a surface to be measured;
at least one level indicating device mounted to the body; and
a strikable device mounted to the level.

2. The level as claimed in claim 1, wherein the strikable device includes a top surface for receiving a striking force, and a bottom surface for contacting the surface to be measured.

3. The level as claimed in claim 2, wherein the strikable device has a first position wherein the bottom surface is within the body of the level and a second position wherein the bottom surface extends outside the body of the level.

4. The level as claimed in claim 1, wherein the strikable device is mounted within the body of the level.

5. The level as claimed in claim 1, wherein the strikable device further comprises a top block, a support block and a rotating block located between the top block and the support block.

6. The level as claimed in claim 5, wherein the strikable device further comprises a spring for connecting and moving the top block and the support block.

7. The level as claimed in claim 1, wherein the level further includes two end caps which are mounted one on each end of the body.

8. The level as claimed in claim 7, wherein the strikable device is mounted to at least one of the end caps.

9. The level as claimed in claim 2, wherein a resilient material is attached to the bottom surface of the strikable device.

10. The level as claimed in claim 9, wherein the resilient material is rubber.

11. The level as claimed in claim 1, wherein the strikable device is movably between a first stored position and a second useable position.

12. The level as claimed in claim 11, wherein when the strikable device is in the usable position, the top surface of the strikable device is outside a top surface of the body.

13. A level comprising:
a body having two opposing ends and a bottom surface for contacting a surface to be measured;
at least one level indicating device mounted to the body; and
a strikable device movably mounted to the body of the level.

14. The level as claimed in claim 13, wherein the strikable device includes at least one protrusion for engagement with at least one recess formed on the body of the level for movably mounting the strikable device to a desired position.

15. The level as claimed in claim 13, wherein the level further comprises end caps mounted on each end of the body and wherein the strikable device is mounted to at least one of the end caps.

16. The level as claimed in claim 13, wherein the strikable device includes an impact resistant material.

17. The level as claimed in claim 16, wherein the material is metal or plastic.

18. The level as claimed in claim 17, wherein resilient material is attached to a bottom contacting surface of the strikable device.

19. The level as claimed in claim 18, wherein the resilient material is rubber.
